(19) United States
(12) Patent Application Publication
(10) Pub. No.: US 2024/0078250 A1
(43) Pub. Date: Mar. 7, 2024

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Chie OHARA, Kanagawa (JP)

(73) Assignee: FUJIFILM BUSINESS INNOVATION CORP., Tokyo (JP)

(21) Appl. No.: 18/176,582

(22) Filed: Mar. 1, 2023

(30) Foreign Application Priority Data
Sep. 7, 2022 (JP) 2022-142045

(51) Int. Cl. G06F 16/27; G06F 16/23

(52) U.S. Cl. CPC G06F 16/275; G06F 16/2358

(57) ABSTRACT

An information processing apparatus, establishing data synchronization with a second information processing apparatus, includes a processor configured to: register, in information processing apparatus update log information, identification information on groups each including related data among data updated in the information processing apparatus; in response to reception of second information processing apparatus update log information including identification information on a group including related data among data updated in the second information processing apparatus, perform a synchronization process by checking the second information processing apparatus update log information against the information processing apparatus update log information, the synchronization process establishing synchronization on data forming each synchronization target group, the synchronization target group being one of the groups and as a synchronization target by the identification information thereof; and delete the identification information on the synchronization target group from the information processing apparatus update log information.

### CROSS-REFERENCE TO RELATED APPLICATIONS

This application is based on and claims priority under 35 USC 119 from Japanese Patent Application No. 2022-142045 filed Sep. 7, 2022.

### BACKGROUND

### (i) Technical Field

The present disclosure relates to an information processing apparatus and a non-transitory computer readable medium.

### (ii) Related Art

Techniques of providing a cloud service by linking a multi-function apparatus serving as a real device with a virtual device on the cloud are available. Without directly accessing the multi-function apparatus, a user may simply access the virtual device on the cloud to use a service, such as image processing, provided by the multi-function apparatus.

The virtual device establishes synchronization with the multi-function apparatus as appropriate to provide the same service as that provided by the multi-function apparatus and thus maintains the same data or the state in which data is mutually associated. Power consumed by the multi-function apparatus may be saved in a power-save mode or a power-off mode and synchronization with the virtual device is difficult to establish in the power-save mode. A synchronization process is not performed at any moment in operation but is periodically performed. Each of the multi-function apparatus and virtual device makes a list of data updated in a synchronization process disabled state and performs the synchronization process on the data registered in the list at the timing when the establishment of the synchronization is enabled.

The techniques described above are disclosed in Japanese Unexamined Patent Application Publication No. 2012-252452 and Japanese Patent No. 6266588.

One piece of data related to another piece of data may be present among data serving as a synchronization target. In such a case, if the one piece of data is synchronized, the other piece of data may also be synchronized. If the one piece of related data is synchronized with the other piece of the related data remaining unsynchronized and either piece of the related data is used, consistency in contents of the related data may be destroyed, leading to an unpredictable event.

### SUMMARY

Aspects of non-limiting embodiments of the present disclosure relate to controlling use of related data in a state in which all the related data remains unsynchronized.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus establishing data synchronization with a second information processing apparatus, comprising a processor configured to: register, in information processing apparatus update log information, identification information on groups each including related data among data updated in the information processing apparatus; in response to reception of second information processing apparatus update log information including identification information on a group including related data among data updated in the second information processing apparatus, perform a synchronization process by checking the second information processing apparatus update log information against the information processing apparatus update log information, the synchronization process establishing synchronization on data forming each synchronization target group, the synchronization target group being one of the groups and as a synchronization target by the identification information thereof; and delete the identification information on the synchronization target group from the information processing apparatus update log information if synchronization is established on all data forming the synchronization target group and the identification information on the synchronization target group is included in the information processing apparatus update log information.

### BRIEF DESCRIPTION OF THE DRAWINGS

Exemplary embodiment of the present disclosure will be described in detail based on the following figures, wherein:

FIG. 1 illustrates an entire configuration and block configuration of a service system of an exemplary embodiment of the disclosure;

FIG. 2 illustrates a data configuration example of group information of the exemplary embodiment;

FIG. 3 illustrates a data setting example of update log information stored in a real device of the exemplary embodiment;

FIG. 4 illustrates a data setting example of the update log information stored in the virtual device of the exemplary embodiment;

FIG. 5 illustrates a sequence chart illustrating a synchronization process of the exemplary embodiment;

FIG. 6 is a flowchart illustrating the synchronization process of data performed by the virtual device of the exemplary embodiment;

FIG. 7 is a flowchart illustrating a first synchronization process of the exemplary embodiment;

FIG. 8 is a flowchart illustrating a second synchronization process of the exemplary embodiment; and

FIG. 9 is a flowchart illustrating a third synchronization process of the exemplary embodiment.

### DETAILED DESCRIPTION

Exemplary embodiment of the disclosure is described below with reference to the drawings.

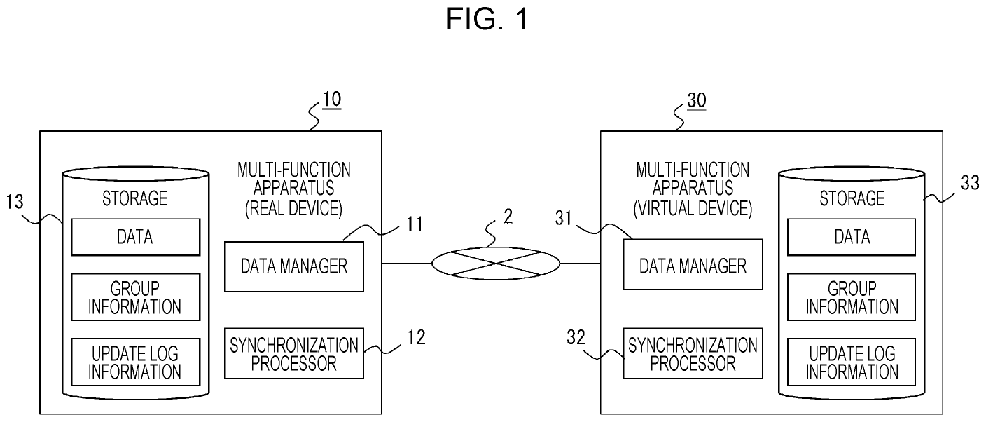

FIG. 1 illustrates an entire configuration and block configuration of a service system of the exemplary embodiment of the disclosure. In the system configuration illustrated in FIG. 1, a multi-function apparatus 10 installed in an on-premises environment is connected to a multi-function apparatus 30 formed on cloud via a network 2, such as the Internet. The multi-function apparatus 10 and multi-function apparatus 30 are capable of two-way communication and establish data synchronization with each other.

The multi-function apparatus 10 is used by a worker (hereinafter referred to as a user) working in the on-premises environment. Since the multi-function apparatus 10 is a real device physically installed in the on-premises environment, the multi-function apparatus 10 is also referred to as a “real device 10.”

The multi-function apparatus 10 is an example of an image forming apparatus having a variety of functions including a print function, copy function, and scanner function and includes a computer. The multi-function apparatus 10 includes a central processing unit (CPU), read-only memory (ROM), random-access memory (RAM), hard disk drive serving a storage storing image data and a confidential box, operation panel serving as a user interface, network interface to be connected to the network 2, print engine, and scanner. The multi-function apparatus 10 may further include, as appropriate, accessory items, such as an access point that performs wireless communication with a radio device carried by the user, card reader that reads a chip card carried by the user, and finisher.

The virtual device 30 is an example of a virtual image forming apparatus implemented by one or more computers. Since the virtual device 30 is formed over the cloud, the virtual device 30 is also referred to as a “virtual device 30.”

The real device 10 and virtual device 30 establish data synchronization therebetween in order to provide the same service to users. The data synchronization signifies that the same data is basically stored on both sides. Part of software (hereinafter referred to as a subset) present in the virtual device 30 may also present in the real device 10. The data synchronization is not construed as limited to signifying that the data stored by both sides are fully identical to each other. According to the exemplary embodiment, the data synchronization signifies the state in which the multi-function apparatuses 10 and 30 cooperating with each other are ready to provide available service using the data stored in each of the multi-function apparatuses 10 and 30.

The term “data” refers to applications and data used in the applications, and a variety of setting values on the multi-function apparatuses 10 and 30. According to the exemplary embodiment, digital data referenced by the multi-function apparatuses 10 and 30 is collectively referred to as data. If the data is an application, synchronization may be established through upgrading of the application or addition of a function to the application.

The real device 10 includes a data manager 11, synchronization processor 12, and storage 13. Elements not described in the discussion of the exemplary embodiment are not illustrated in the drawings. The data manager 11 manages data used by the real device 10. In particular, when data to be synchronized is updated, the data manager 11 references group information and registers the group information in the update log information. The synchronization processor 12 establishes data synchronization by performing the synchronization process with the virtual device 30. The data, group information, and update log information are stored in the storage 13. The data is processed by the real device 10 and includes data that serves as an update target.

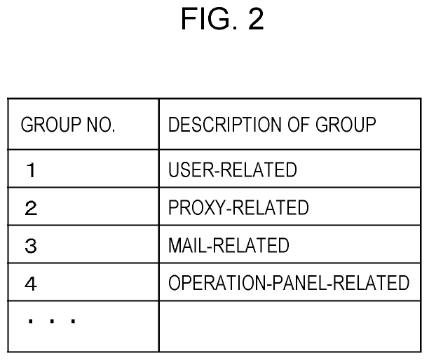

FIG. 2 illustrates a data configuration example of the group information of the exemplary embodiment. As described in greater detail below, in the context of the disclosure, the synchronization process is performed such that data synchronization is established on a per group unit basis. Information used to group the data serving as a synchronization target is set in the group information. A group number serving as identification information on each group and information (group description) describing a feature of data grouped in the same group are set in association in the group information. Specifically, each group includes data having the same feature, namely, data that is mutually related, and pieces of the related data are tagged with the same group number. Grouping criteria in FIG. 2 are illustrated for exemplary purposes only and the disclosure is not limited to the group criteria illustrated herein.

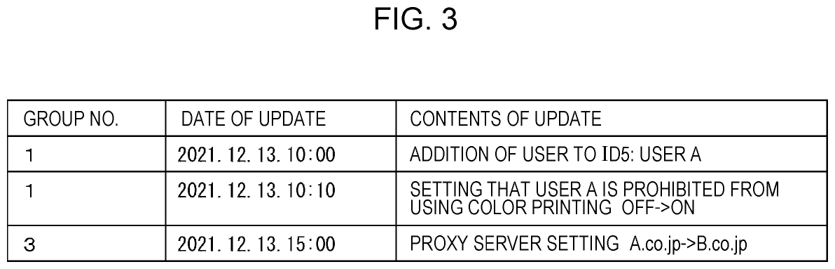

FIG. 3 illustrates a data setting example of update log information stored in the real device 10 of the exemplary embodiment. The update log information is data updated in the real device 10, namely, log information related to data that is to be synchronized, and thus information on the data serving a synchronization target. The update log information includes the group number, date of update, and contents of update in an associated form. The group number is a group number of a group to which the data serving the synchronization target belongs. The date of update refers to a date on which the data is updated. The contents of update refers to updated contents of the update data.

According to the exemplary embodiment, the data registered in the update log information, namely, the data serving as the synchronization target is updated only after the synchronization process is performed. Specifically, in a precise sense, the data updated by a system or user refers to data for which a data update request is made. If the request to update the data is made, contents of the requested update indicate only a registration in the update log information. The data is still not updated at the registration of the data to the update log information. When the synchronization process is performed on the data, the data is really updated. The updating of the data includes addition of data, modification of data, and deletion of data.

The data manager 11 and synchronization processor 12 in the real device 10 are implemented when a computer forming the real device 10 and a program running on the CPU in the computer operate cooperatively. The storage 13 is implemented by a hard disk drive (HDD) mounted on the real device 10. Alternatively, the storage 13 may be a RAM or an external memory connected via a network.

The virtual device 30 includes a data manager 31, synchronization processor 32, and storage 33. Elements not described in the discussion of the exemplary embodiment are not illustrated either in FIG. 1. The elements of the virtual device 30 may be substantially identical to those of the real device 10. According to the exemplary embodiment, the virtual device 30 performs a leading role in the synchronization process and the virtual device 30 is different from the real device 10 in terms of the contents of specific operations in the synchronization process. Alternatively, the real device 10 may perform a leading role in the synchronization process. The group information stored in the storage 33 is fully identical to the group information stored in the real device 10. Specifically, a group of data having the same feature may be tagged with the same group number. The update log information is data for which the data update request is made in the virtual device 30, namely, the update log information is log information related to the data that is to be synchronized, and thus information related to the data serving as a synchronization target. The structure of the stored data is identical to the update log information in the real device 10.

The data manager 31 and synchronization processor 32 in the virtual device 30 are implemented when a computer forming the virtual device 30 and a program running on the CPU in the computer operate cooperatively. The storage 33 is implemented by an HDD mounted on the virtual device 30. Alternatively, the storage 33 may be a RAM or external memory connected via a network.

A program used in the exemplary embodiment may be delivered via a communication medium. Alternatively, the program may be delivered in a recorded form on a computer readable recording medium, such as a universal serial bus (USB) memory. The program delivered via the communication medium or the recording medium is installed on the computer and when the CPU in the computer successively executes the program, a variety of processes are performed.

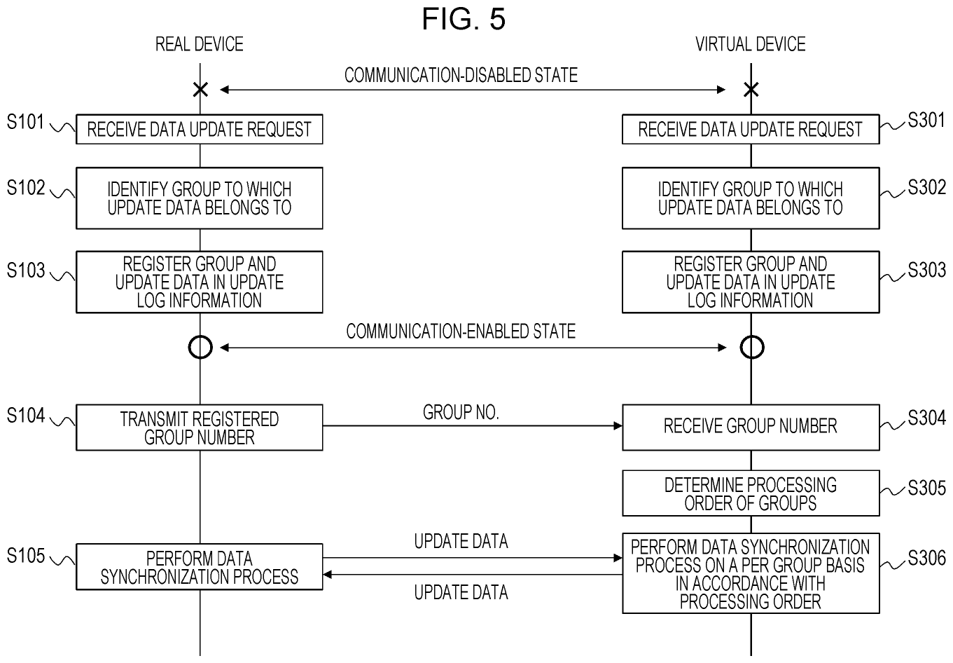

The synchronization process characteristic of the exemplary embodiment is described with reference to a sequence chart illustrated in FIG. 5.

The multi-function apparatuses 10 and 30 provide identical services. The synchronization process performed to establish data synchronization between the multi-function apparatuses 10 and 30 is triggered by an inquiry that the real device 10 performs onto the virtual device 30 at a specific timing. During the power saving state with the real device 10 powered off or in the power-save mode, communication is disabled and data synchronization is difficult to achieve. There is a period of time in operation during which data synchronization is disabled. In the beginning of the sequence illustrated in FIG. 5, the real device 10 is in the power save state and the communication is disabled. The data synchronization is thus difficult to achieve.

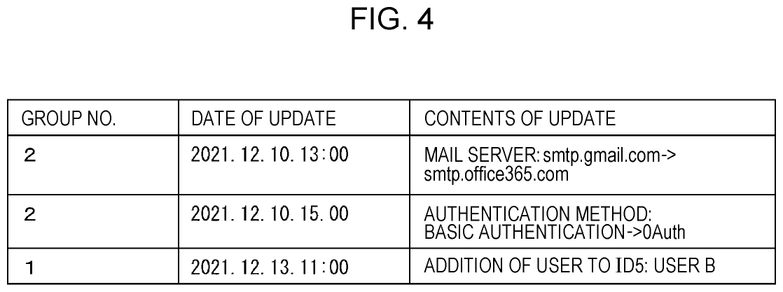

The data manager 31 in the virtual device 30 receives a data update request during the data synchronization disabled period (step S301), determines the type of data (hereinafter referred to as “update data”) for which an update is requested (step S302), and references the group information to identify a group to which the update data belongs (step S302). The data manager 31 creates the update log information by setting, to be the date of update, date on which the update request is made on the identified group and by setting the contents of the update data to be the contents of update. The data manager 31 thus registers the update log information on the storage 33 (step S303). During the synchronization disabled state, the data manager 31 creates the update log information in response to the data update request and thus accumulates the update log information as illustrated in FIG. 4.

When the real device 10 receives the data update request during the data synchronization disabled period as the virtual device 30 does, the real device 10 creates the update log information and accumulates the update log information as illustrated in FIG. 3 (steps S101 through S103).

The synchronization is disabled not only when the real device 10 is in the power-save mode but also when the network 2 is inoperative, or the cloud of the virtual device 30 is system-down or in the middle of maintenance.

A process performed when the multi-function apparatuses 10 and 30 are enabled to communicate each other with the real device 10 having exited the power-save mode is described below. According to the exemplary embodiment, as previously described, the virtual device 30 has the leading role in the synchronization process.

When the multi-function apparatuses 10 and 30 are enabled to communicate with each other with the real device 10 having existed the power-save mode, the synchronization processor 12 notifies the virtual device 30 that the real device 10 has exited the power-save mode. In cooperation with the synchronization processor 32 in the virtual device 30, the synchronization processor 12 starts the synchronization process with the virtual device 30 after the power-save mode. Specifically, in response to the detection of the real device 10 that has exited the power-save mode, the synchronization processor 32 in the virtual device 30 inquires of the real device 10 the presence or absence of data serving as a synchronization target.

In response to the inquiry from the virtual device 30, the synchronization processor 12 in the real device 10 references the update log information. If the update data registered is present, the synchronization processor 12 transmits to the virtual device 30 a list of group numbers responsive to the update data (step S104). In this way, the synchronization processor 32 acquires the group number of the update data in the real device 10 (step S304).

The synchronization processor 32 references the group number acquired from the real device 10 and the group number in the virtual device 30, namely, the group number included in the update log information registered in the storage 33, and determines a processing order of a group to be synchronized (step S305). In the setting examples illustrated in FIGS. 3 and 4, group numbers 1, 2, and 3 in the multi-function apparatuses 10 and 30 are registered in the update log information. According to the exemplary embodiment, synchronization is sequentially established on a per group basis and the processing order of the group numbers 1, 2, and 3 is to be determined.

A rule may be set in advance in connection with a determination method of the processing order. For example, the synchronization process is performed in the order of smaller to larger group number. According to the exemplary embodiment, any group number may be assigned to any group. For example, data related to security or billing is considered of great value in the operation of the service system. If a group having a higher degree of importance is tagged with a smaller group number, synchronization may be established starting with the data having the higher degree of importance.

Data having a higher usage frequency may be synchronized with a higher priority by referencing job log information (not illustrated) and a variety of other log information (not illustrated).

Not only the group number included in the update log information but also the whole update log information is to be acquired from the real device 10. In such a case, synchronization may be established in a chronological order. Specifically, the update data having the oldest date of update in groups is compared and the synchronization process is performed in the order of group starting with a group having the oldest date of update.

The synchronization process may be performed on the update data in the order from higher to lower number of registrations in the groups. Since the usage frequencies may happen to be equal and number of registrations may happen to be equal, the decision methods of the processing order may be appropriately combined.

As described above, the synchronization processor 32 determines the processing order of the synchronization process. In the following discussion, the synchronization process is performed in the order of group numbers 1, 2, and 3.

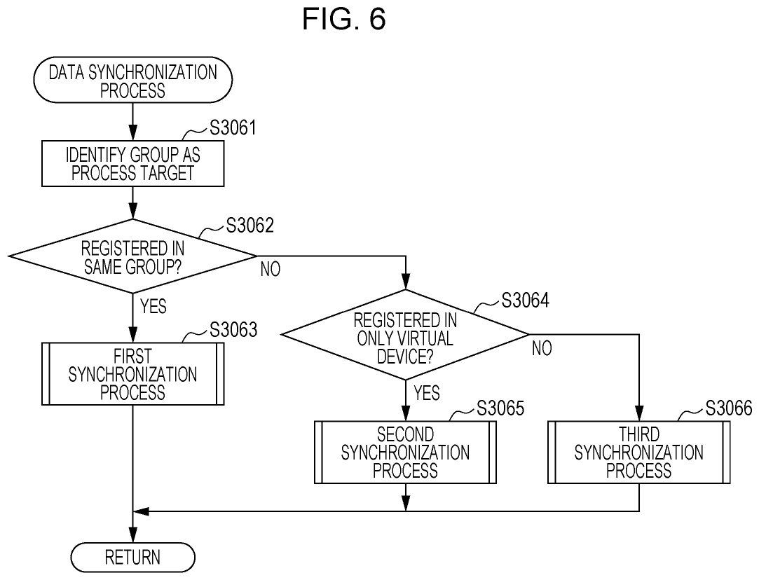

The order of processing the groups is thus determined. In cooperation with the synchronization processor 12, the synchronization processor 32 performs the synchronization process on each group in the determined processing order (steps S105 and S306). The synchronization process in which the synchronization processor 32 has the leading role is described in greater detail (step S306) with reference to a flowchart in FIG. 6.

The synchronization processor 32 performs sequentially the synchronization process on a group serving as a process target as described above. The synchronization processor 32 thus identifies the group serving as the process target in the processing order (step S3061). The synchronization processor 32 checks the group number acquired from the real device 10 against the group number of the update log information registered in the storage 33. If the identified group is registered in both the multi-function apparatuses 10 and 30 (yes path in step S3062), the synchronization processor 32 performs a first synchronization process (step S3063). If the identified group is not registered in both the multi-function apparatuses 10 and 30 (no path in step S3062) but is registered in only the virtual device 30 (yes path in step S3064), the synchronization processor 32 performs a second synchronization process (step S3065). On the other hand, if the identified group is registered in only the real device 10 (no path in step S3064), the synchronization processor 32 performs a third synchronization process (step S3066).

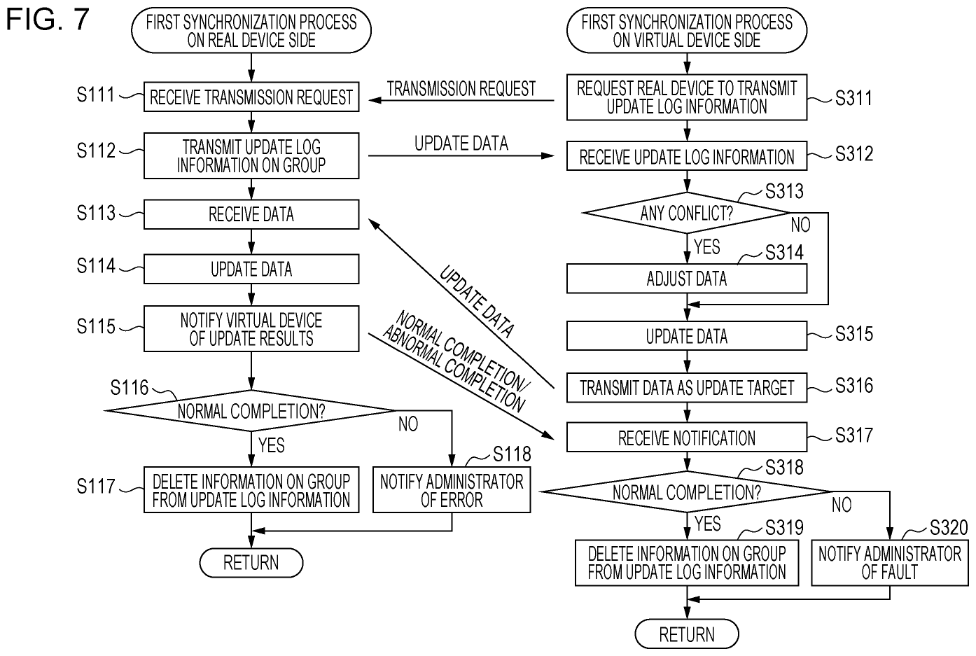

In the setting example of the update log information in FIGS. 3 and 4, the group 1 is registered in both the real device 10 and virtual device 30 and thus a process target of the first synchronization process. The group 2 registered only in the virtual device 30 is thus a process target of the second synchronization process. The group 3 registered only in the real device 10 is thus a process target of the third synchronization process. The first through third synchronization processes are described below. Each synchronization process performed by the real device 10 is included in step S105 in FIG. 5. Each synchronization process performed by the virtual device 30 is included in step S306 in FIG. 5. The first synchronization process is described with reference to a flowchart in FIG. 7 together with the setting example of the update log information illustrated in FIGS. 3 and 4.

The synchronization processor 32 requests the real device 10 to transmit the update log information on the group 1 serving as the process target (step S311).

After notifying the virtual device 30 that the real device 10 has exited the power-save mode, the synchronization processor 12 in the real device 10 waits on standby for a reception from the virtual device 30. When the synchronization processor 12 receives a transmission request of the update log information on the group 1 from the virtual device 30 (step S111), the synchronization processor 12 retrieves the update log information on the group 1 from the storage 13 in response to the received transmission request and transmits the update log information on the group 1 to the virtual device 30 (step S112). When the update log information is transmitted in response to the transmission request, the synchronization processor 12 waits on standby for a reception from the virtual device 30.

The synchronization processor 32 in the virtual device 30 receives the update log information from the real device 10 (step S312), and checks the received update log information on the group 1 against the contents of the update log information on the group 1 stored in the storage 33 to check for the presence or absence of a conflict. In the setting example in FIGS. 3 and 4, “user A” is registered in user identification information “ID5” in the real device 10 and “user B” is registered in user identification information “ID5” in the virtual device 30. The update log information on the real device 10 and the update log information on the virtual device 30 include pieces of data (hereinafter referred to as parameters) different in setting contents, namely, the user A and the user B, set for the same data item, namely, the user identification information ID5. If different parameters are set in the real device 10 and the virtual device 30, a fault may be possibly caused. If a conflict occurs (yes path in step S313), the synchronization processor 32 makes an adjustment such that data synchronization is established in accordance with a predetermined rule in a manner free from contradiction (step S314).

The predetermined rule may be, for example, that earlier setting is prioritized. In the setting example in FIGS. 3 and 4, the update log information on the real device 10 is selected since the addition of the user A is earlier. In this case, the synchronization processor 32 automatically assigns still unused user identification information, for example, “ID6” to the user B. If automatic assignment is difficult to perform in a data item, the user may get in touch with an administrator. Chronologically older update data may be destroyed. In such a case, the addition of the user B is not performed. If personal information is accessible, information, such as belonging department, job category, and position may be referred to and priority users may thus be determined.

There is no conflict in second update log information on the group 1 on the real device 10, namely, in the update data indicating that the setting that the user A is prohibited from using color printing is set from off to on (no path in step S313). The adjustment described above is not performed.

As described above, the update data is adjusted in response to the occurrence of a conflict with respect to the same user identification information ID5. However, it is advisable to make sure that the adjustment of one piece of update data does not affect the other pieces of update data.

The synchronization processor 32 in the virtual device 30 updates the data in accordance with the adjusted update log information on the group 1 (step S315). The synchronization processor 32 transmits the data as an update target to the real device 10 (step S316).

The synchronization processor 12 in the real device 10 receives the data from the virtual device 30 (step S113), determines that the data is an update instruction to update data included in the received group 1, and updates the data on the real device 10 with the received data (step S114). The real device 10 and virtual device 30 exchange the update log information on the same group 1 and respectively synchronize the update data.

Although the data as the update target that the virtual device 30 transmits in step S316 includes the update log information on the real device 10 and the update log information on the virtual device 30, the synchronization processor 32 may not necessarily transmit the update log information on the group 1 registered in the storage 13 in the real device 10. It is noted, however, that the update data may have been adjusted. For example, the update data “user B” registered in the virtual device 30 rather than the update data “user A” registered in the storage 13 may be set for the user identification information ID5. In view of the possibility that the adjustment has been performed, the synchronization processor 32 may transmit to the real device 10 all the update data belonging to the group 1 that is to be reflected on the real device 10.

As described above, in response to the data update request received during the data synchronization disabled period, the data managers 11 and 31 create and accumulate the update log information (steps S101 through S103 and S301 through S303) and do not update the data serving as the update target stored in the storages 13 and 33. If the data managers 11 and 31 have actually updated the data stored in the storages 13 and 33 in response to the update request from the system or user, there may be a case in which the data adjustment is to be performed in step S314. In such a case, once updated data may be reverted back to the update data prior to the adjustment or the data subsequent to the adjustment may be updated again. Such an operation may possibly lead to an unpredictable event.

According to the exemplary embodiment, the data for which a data update request is received during the data synchronization disabled period is only registered in the update log information. The data is then updated in the synchronization process characteristic of the exemplary embodiment.

The synchronization processor 12 in the real device 10 updates all the update data included in the same group, namely, the group 1. The synchronization processor 12 notifies the virtual device 30 of the update results of the update data in the group 1 serving as the process target (step S115). If the updating of the update data is normally completed (yes path in step S116), the synchronization processor 12 deletes the update log information on the group 1 serving as the process target among the update log information stored in the storage 13 (step S117).

If the updating of the update data is not normally completed (no path in step S116), the synchronization processor 12 notifies the administrator of the occurrence of a fault in the synchronization process of the update data on the group 1 (step S118). If a fault has occurred, the synchronization processor 12 does not delete the update log information on the group 1 having the fault. In this way, updating of the update data included in the group 1 is performed again in the next or subsequent synchronization process.

After transmitting the data serving as the update target, the synchronization processor 32 in the virtual device 30 waits on standby for the notification of the update results of the synchronization process of the transmitted update data from the real device 10. When the notification of the update results of the synchronization process is received (step S317) and if the update results indicate a normal completion (yes path in step S318), the synchronization processor 32 deletes the update log information on the group 1 serving as the process target among the update log information stored in the storage 33 (step S319). According to the exemplary embodiment, the update log information on the group 1 is deleted after the completion of the updating of the update data in both the real device 10 and virtual device 30 is confirmed.

If the synchronization process is not normally completed on the real device 10 (no path in step S318), the synchronization processor 32 notifies the administrator or the like that a fault has occurred in the synchronization process of the group 1 (step S320). If a fault has occurred, the synchronization processor 32 does not delete the update log information on the group 1 having the fault. In this way, the update log information on the group 1 is not deleted but remains stored in the real device 10 and the virtual device 30. The synchronization of the update data included in the group 1 is performed again in the next or subsequent synchronization process.

According to the exemplary embodiment, as described above, the virtual device 30 performs the leading role to perform the synchronization process on the group with the update log information registered in both the real device 10 and virtual device 30.

As described above, the virtual device 30 updates the update data in step S315, and then the real device 10 updates the update data in step S114. The virtual device 30 may perform the data updating in step S315, after confirming that the data updating is normally completed on the real device 10 (yes path in step S318), namely, immediately prior to step S319.

As described above, the data updating on the virtual device 30 (step S315) is performed on condition that data updating is normally completed. As the real device 10 confirms the ending state of the data updating, the virtual device 30 may do the same. The virtual device 30 may notify the real device 10 of the confirmation results. The same is true of the second and third synchronization processes.

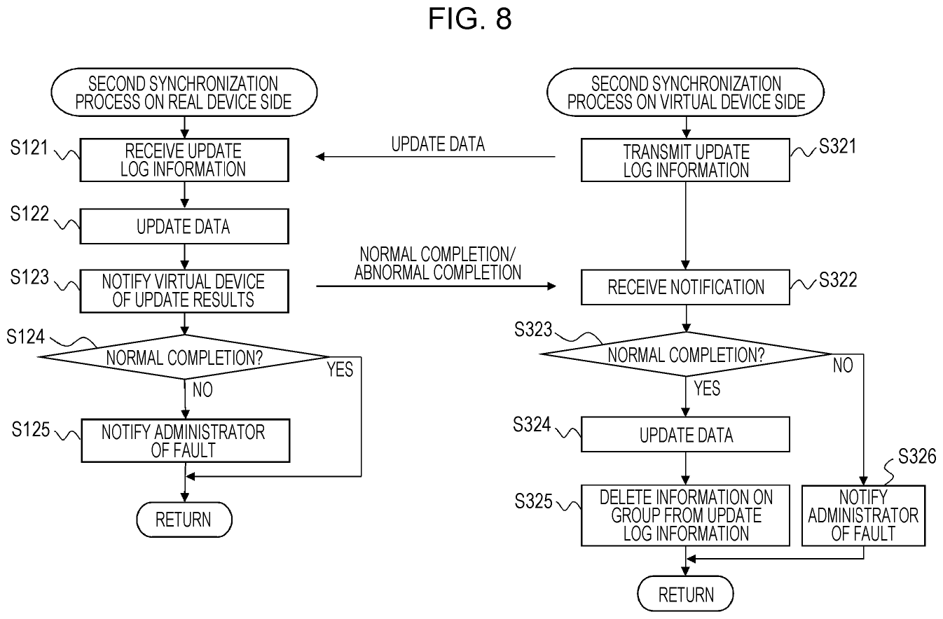

The second synchronization process is described with reference to a flowchart in FIG. 8 together with the setting example of the update log information in FIGS. 3 and 4.

In the second synchronization process, the update log information on the group is registered only in the virtual device 30. In the setting example of the update log information in FIGS. 3 and 4, the group 2 applies in the second synchronization process. Specifically, the update log information on the group 2 is included in the update log information registered in the storage 33 while the update log information on the group 2 is not included in the update log information registered in the storage 13.

In the second synchronization process, the synchronization processor 32 provides an instruction to establish synchronization by transmitting the update log information on the group 2 to the real device 10 (step S321).

The synchronization processor 12 in the real device 10 waits on standby for a reception from the virtual device 30 after notifying the virtual device 30 that the real device 10 has exited the power-save mode. In response to the reception of the update log information from the virtual device 30 (step S121), the synchronization processor 12 determines that the update log information is an update instruction for the group 2 included in the received update log information and updates data on the real device 10 with the update data included in the update log information (step S122). In this way, the synchronization processor 12 in the real device 10 updates all the update data included in the group 2. The synchronization processor 12 notifies the virtual device 30 of the execution results of an update process of the update data in the group 2 (step S123). If the update process of the update data is normally completed (yes path in step S124), the update log information on the group 2 is not registered in the storage 13 and the second synchronization process thus ends.

If the updating of the update data is not normally completed (no path in step S124), the synchronization processor 12 notifies the administrator or the like that a fault has occurred in the data synchronization process of the group 2 (step S125).

After transmitting the update log information, the synchronization processor 32 in the virtual device 30 waits for the notification of the execution results of the update process from the real device 10. When the notification of the execution results of the update process is received (step S322) and if the execution results indicate a normal completion (yes path in step S323), the synchronization processor 32 updates the update data in accordance with the update log information on the group 2 among the update log information stored in the storage 33 (step S324). In succession, the synchronization processor 32 deletes the update log information on the group 2 serving as the process target among the update log information stored in the storage 33 (step S325). According to the exemplary embodiment, the synchronization processor 32 deletes the update log information on the group 2 after confirming that the updating of the update log information is normally completed on both the real device 10 and virtual device 30.

If the synchronization process is not normally completed on the real device 10 (no path in step S323), the synchronization processor 32 notifies the administrator or the like that a fault has occurred in the synchronization process of the group 2 (step S326). If a fault has occurred, the synchronization processor 32 does not delete the update log information on the group 2 having the fault. The synchronization of the update data included in the group 2 is performed again in the next or subsequent synchronization process.

According to the exemplary embodiment, under the leading role of the virtual device 30, the synchronization process is performed on the group with the update log information registered in only the virtual device 30.

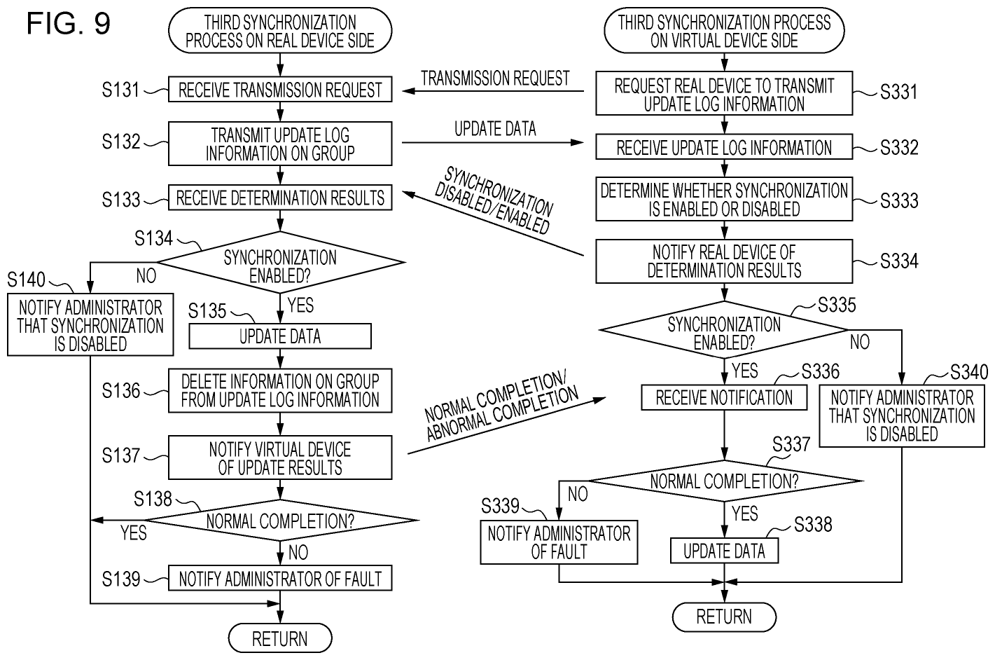

The third synchronization process is described with reference to a flowchart in FIG. 9 together with the setting example of the update log information in FIGS. 3 and 4.

In the third synchronization process, the update log information on a group is registered only in the real device 10. In the setting example of the update log information in FIGS. 3 and 4, the group 3 applies in the second synchronization process. Specifically, the update log information on the group 3 is included in the update log information registered in the storage 13 while the update log information in the group 3 is not included the update log information registered in the storage 33.

In the third synchronization process, the synchronization processor 32 requests the real device 10 to transmit the update log information on the group 3 (step S331).

The synchronization processor 12 in the real device 10 waits on standby for a reception from the virtual device 30 after notifying the virtual device 30 that the real device 10 has exited the power-save mode. In response to the reception of a transmission request for the update log information on the group 3 from the virtual device 30 (step S131), the synchronization processor 12 retrieves the update log information on the group 3 from the storage 13 in response to the received transmission request and the transmits the update log information on the group 3 to the virtual device 30 (step S132). When the update log information is transmitted in response to the transmission request for the update log information, the synchronization processor 12 waits on standby for a reception from the virtual device 30.

In response to the reception of the update log information from the real device 10 (step S332), the synchronization processor 32 in the virtual device 30 determines whether to update data with the update data included in the received update log information, in other words, determines whether the data synchronization is enabled (step S333). Mail server and authentication method is to be combined appropriately. For example, if the mail server is “smtp.office365.com,” the authentication method is limited to “OAuth.” If the mail server is “smtp.gmail.com,” “OAuth” is not usable as an authentication method. Whether the data synchronization is enabled or not is to be determined in advance to ensure that a feasible combination of mail server and authentication method is achieved.

The synchronization processor 32 determines whether the data synchronization is enabled or not on the update data and then notifies the real device 10 of the determination results (step S334). The synchronization processor 32 then waits on standby for a reception of the execution results of data updating from the real device 10.

The synchronization processor 12 in the real device 10 in the reception waiting state receives the determination results from the virtual device 30 (step S133). If the determination results indicate that synchronization is enabled (yes path in step S134), the synchronization processor 12 regards the determination results as an update instruction of data and thus updates the data on the real device 10 with the update data included in the update log information on the group 3 registered in the storage 13 (step S135). The synchronization processor 12 then deletes the update log information on the group 3 serving as the process target among the update log information stored in the storage 13 (step S136). The synchronization processor 12 notifies the virtual device 30 of the execution results of the update process on the update data in the group 3 serving as the process target (step S137).

If the update process on the update data in the group 3 serving as the process target is normally completed (yes path in step S138), the synchronization processor 12 ends the process. On the other hand, if the data updating is not normally completed (no path in step S138), the synchronization processor 12 notifies the administrator or the like that a fault has occurred in the data synchronization process of the group 3 (step S139).

If the determination results received from the virtual device 30 indicate that synchronization is not enabled (no path in step S134), the synchronization processor 12 notifies the administrator or the like that the synchronization process is disabled (step S140). If synchronization is disabled, the virtual device 30 may notify the real device 10 of the determination results and the reason why the synchronization process is determined to be disabled, thereby notifying the administrator or the like of the real device 10 of the determination results and the reason.

If synchronization is determined to be enabled in step S333 (yes path in step S335), the synchronization processor 32 in the reception waiting state receives a notification of update results of data (step S336). If the update results indicate a normal completion (yes path in step S337), the synchronization processor 32 updates data with the update data included in the update log information on the group 3 received in step S332 (step S338). Since the data synchronization is determined in step S333 to be enabled, the synchronization processor 32 determines that the data updating is normally completed.

If the data updating is not normally completed on the real device 10 (no path in step S337), the synchronization processor 32 notifies the administrator or the like of the occurrence of the fault in the synchronization process of the group 3 (step S339).

On the other hand, if synchronization is determined to be not enabled in step S333 (no path in step S335), the synchronization processor 32 notifies the administrator or the like that the synchronization process on the update data included in the group 3 is disabled (step S340).

According to the exemplary embodiment, under the leading role of the virtual device 30, the synchronization process may be performed on the group with the update log information registered only in the real device 10.

The synchronization process to be performed with the system having existed the power-save mode has been described. The synchronization process may be similarly performed in the middle of the operation of the multi-function apparatuses 10 and 30. The synchronization process is typically performed as a scheduled or periodic process in the middle of the operation of the multi-function apparatuses 10 and 30. The scheduled process may inhibit accessing to at least the data serving as an update target in order to ensure data consistency.

To restrict a data access inhibit period, a time length (hereinafter referred to as a “synchronization enabled period”) throughout which the synchronization process is enabled to continue may be limited. For example, if the synchronization enabled period is set to 2 minutes, the synchronization process may be force-ended when 2 minutes elapse. If the synchronization process is performed under this condition with a large amount of the update log information included in a group, it may be difficult to complete the synchronization process within the synchronization enabled period.

If predicted time lengths of the groups 1, 2, and 3 are respectively 30 seconds, 1 minutes, and 3 minutes with the synchronization enabled period being 2 minutes, the synchronization of the groups 1, 2, and 3 is not completed within a single cycle of the synchronization process. In such a case, according to the exemplary embodiment, the synchronization is controlled as described below.

Groups (groups 1 and 2 in this example herein) that permit synchronization to be completed within the synchronization enabled period are extracted and the synchronization process is performed on the extracted groups. The synchronization process is not performed on the group 3 having the time length in excess of 2 minutes. If the presence of a group (such as the group 3) having a predicted time length in excess of the synchronization enabled period is detected, the synchronization processor 32 prolongs the synchronization enabled period to the predicted time length of the group 3 (3 minutes) such that the synchronization of the group 3 is possible. The synchronization of only the group 3 is performed in the next synchronization process and the synchronization enabled period is then reverted back to the original synchronization enabled period of 2 minutes. Alternatively, the synchronization enabled period may be set to 3 minutes or longer such that the synchronization process is performed on the group 3 together with other groups. In either case, after the synchronization process is performed with the synchronization enabled period prolonged, the synchronization enabled period may be reverted back to the original value of 2 minutes. This is because the synchronization enabled period is limited such that the users of the multi-function apparatuses 10 and 30 are free from any inconvenience. The synchronization process with the synchronization enabled period prolonged may be performed when the multi-function apparatuses 10 and 30 are used less frequently, for example, during the night. Whether the synchronization process is performed in a next cycle or during the night may be determined by referencing the priority degree of the update data included in the group having the predicted time length in excess of the synchronization enabled period.

Even when the synchronization process is performed on only the groups that permit the synchronization process to be completed within the synchronization enabled period (for example, the groups 1 and 2), a delay may occur due to communication failure and as a result, the synchronization process is difficult to complete within the synchronization enabled period. In such a case, the synchronization process may be performed in a next cycle on the group with the synchronization process thereof not completed within the synchronization enabled period.

If the number of pieces of the update log information included in a group is equal to or above a threshold, the update data included in the same group may be divided into subgroups and the synchronization process may be performed on a per subgroup basis. The synchronization process on the subgroup is controlled such that the synchronization process is completed within the synchronization enabled period. In this case, the synchronization process does not involve prolonging the synchronization enabled period. As described with reference to the combination of mail server and authentication method, the synchronization process at different timings is to be controlled, namely, more relevant update data is included in the same subgroup. As with the case of the groups, the priority of each of the subgroups may be determined according to the degree of importance.

During the synchronization process, the data may further be updated. Specifically, update log information is created during the synchronization process and the created update log information is to be included in the update log information in the corresponding group. For example, with the groups 1, 2, and 3 being synchronized in this order, the group 1 may now be in the middle of the synchronization process. If the update request is made for data corresponding to the group 1 in the progress of the synchronization process, a determination is made as to whether to synchronize the data in the middle of the current synchronization process in accordance with a predetermined condition. For example, the predetermined condition may be that the group 3 is followed by the group 1 in the synchronization process. In such a case, a series of synchronization processes may be performed with the group 3 followed by the group 1. Alternatively, the operation in step S305 in FIG. 5 may be performed to determine the processing order again, namely, in the order of the group 2, the group 3, and the group 1. Alternatively, the group 1 may be shifted to the next or subsequent synchronization process.

If the update request is made for data in the unprocessed group 2 or 3 with the group 1 in the middle of the synchronization process, the data may be included in the update log information on the group 2 or 3. Alternatively, the data updating may be shifted to the next or subsequent synchronization process.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus establishing data synchronization with a second information processing apparatus, comprising:
a processor configured to:
   register, in information processing apparatus update log information, identification information on groups each including related data among data updated in the information processing apparatus;
   in response to reception of second information processing apparatus update log information including identification information on a group including related data among data updated in the second information processing apparatus, perform a synchronization process by checking the second information processing apparatus update log information against the information processing apparatus update log information, the synchronization process establishing synchronization on data forming each synchronization target group, the synchronization target group being one of the groups and as a synchronization target by the identification information thereof; and
   delete the identification information on the synchronization target group from the information processing apparatus update log information if synchronization is established on all data forming the synchronization target group and the identification information on the synchronization target group is included in the information processing apparatus update log information.
      (((2)))

The information processing apparatus according to (((1))), wherein the processor is configured to, if the synchronization target group is included in both the information processing apparatus update log information and the second information processing apparatus update log information, establish synchronization in the synchronization process by exchanging the data forming the synchronization target group.

(((3)))

The information processing apparatus according to (((2))), wherein the processor is configured to, if data of a specific data item is included in but has different contents in the information processing apparatus update log information and in the second information processing apparatus update log information, make an adjustment to establish synchronization on the data of the specific data item in accordance with a predetermined rule.

(((4)))

The information processing apparatus according to (((1))), wherein the processor is configured to, if a group included in the information processing apparatus update log information but not included in the second information processing apparatus update log information is present, provide an instruction in the synchronization process to establish synchronization by transmitting data forming the group included in the information processing apparatus update log information but not included in the second information processing apparatus update log information to the second information processing apparatus.

(((5)))

The information processing apparatus according to (((2))) or (((4))), wherein the processor is configured to, after receiving from the second information processing apparatus a notification that synchronization of all data forming the synchronization target group has been normally established, delete the identification information on the synchronization target group from the information processing apparatus update log information.

(((6)))

The information processing apparatus according to (((1))), wherein the processor is configured to, if a group included in the second information processing apparatus update log information but not included in the information processing apparatus update log information is present, establish synchronization in the synchronization process by receiving data forming the group included in the second information processing apparatus update log information but not included in the information processing apparatus update log information from the second information processing apparatus.

(((7))

The information processing apparatus according to (((2))) or (((4))), wherein the processor is configured to transmit to the second information processing apparatus a notification that synchronization of all the data forming the synchronization target group has been normally established.

(((8)))

The information processing apparatus according to (((1))), wherein the processor is configured to, if data to be included in the synchronization target group is updated in the information processing apparatus with the synchronization target group being in a present synchronization process, determine whether to establish synchronization on the updated data in the present synchronization process in accordance with a predetermined condition.

An information processing apparatus establishing data synchronization with a second information processing apparatus, comprising:
a processor configured to:
   register, in update log information, identification information on groups each including related data among data updated in the information processing apparatus;
   transmit the update log information to the second information processing apparatus at a start of a synchronization process of the data; and
   perform in response to the transmission of the update log information the synchronization process on each synchronization target group specified by the second information processing apparatus to establish synchronization on data forming the synchronization group, the synchronization target group being one of the groups.
      (((10)))

The information processing apparatus according to (((9))), wherein the processor is configured to, if the identification information on the synchronization target group has been registered in the update log information, delete the identification information on the synchronization target group from the update log information after the synchronization process is normally completed.

(((11)))

The information processing apparatus according to (((9))), wherein the processor is configured to, if the synchronization process is normally completed, transmit a notification of a normal completion to the second information processing apparatus.

(((12)))

The information processing apparatus according to (((1))) or (((9))), wherein the second information processing apparatus is formed on a cloud.

(((13)))

A program causing a computer to execute a process for processing information, the process comprising:
registering, in information processing apparatus update log information, identification information on groups each including related data among data updated in an information processing apparatus;
in response to reception of second information processing apparatus update log information including identification information on a group including related data among data updated in a second information processing apparatus, performing a synchronization process by checking the second information processing apparatus update log information against the information processing apparatus update log information, the synchronization process establishing synchronization on data forming each synchronization target group, the synchronization target group being one of the groups and being identified as a synchronization target by the identification information thereof; and
deleting the identification information on the synchronization target group from the information processing apparatus update log information if synchronization is established on all data forming the synchronization target group and the identification information on the synchronization target group is included in the information processing apparatus update log information.
   (((14)))

A program causing a computer to execute a process for processing information, the process including:
registering, in update log information, identification information on a group including related data among data updated in the information processing apparatus;
transmitting the update log information to the second information processing apparatus at a start of a synchronization process of the data; and
performing in response to the transmission of the update log information the synchronization process on each group specified by the second information processing apparatus to establish synchronization on data forming the group.

What is claimed is:

1. An information processing apparatus establishing data synchronization with a second information processing apparatus, the information processing apparatus comprising:
a processor configured to:
register, in information processing apparatus update log information, identification information on groups each including related data among data updated in the information processing apparatus;
in response to reception of second information processing apparatus update log information including identification information on a group including related data among data updated in the second information processing apparatus, perform a synchronization process by checking the second information processing apparatus update log information against the information processing apparatus update log information, the synchronization process establishing synchronization on data forming each synchronization target group, the synchronization target group being one of the groups and as a synchronization target by the identification information thereof; and
delete the identification information on the synchronization target group from the information processing apparatus update log information if synchronization is established on all data forming the synchronization target group and the identification information on the synchronization target group is included in the information processing apparatus update log information.

2. The information processing apparatus according to claim 1, wherein the processor is configured to, if the synchronization target group is included in both the information processing apparatus update log information and the second information processing apparatus update log information, establish synchronization in the synchronization process by exchanging the data forming the synchronization target group.

3. The information processing apparatus according to claim 2, wherein the processor is configured to, if data of a specific data item is included in but has different contents in the information processing apparatus update log information and in the second information processing apparatus update log information, make an adjustment to establish synchronization on the data of the specific data item in accordance with a predetermined rule.

4. The information processing apparatus according to claim 1, wherein the processor is configured to, if a group included in the information processing apparatus update log information but not included in the second information processing apparatus update log information is present, provide an instruction in the synchronization process to establish synchronization by transmitting data forming the group included in the information processing apparatus update log information but not included in the second information processing apparatus update log information to the second information processing apparatus.

5. The information processing apparatus according to claim 2, wherein the processor is configured to, after receiving from the second information processing apparatus a notification that synchronization of all data forming the synchronization target group has been normally established, delete the identification information on the synchronization target group from the information processing apparatus update log information.

6. The information processing apparatus according to claim 4, wherein the processor is configured to, after receiving from the second information processing apparatus a notification that synchronization of all data forming the synchronization target group has been normally established, delete the identification information on the synchronization target group from the information processing apparatus update log information.

7. The information processing apparatus according to claim 1, wherein the processor is configured to, if a group included in the second information processing apparatus update log information but not included in the information processing apparatus update log information is present, establish synchronization in the synchronization process by receiving data forming the group included in the second information processing apparatus update log information but not included in the information processing apparatus update log information from the second information processing apparatus.

8. The information processing apparatus according to claim 2, wherein the processor is configured to transmit to the second information processing apparatus a notification that synchronization of all the data forming the synchronization target group has been normally established.

9. The information processing apparatus according to claim 4, wherein the processor is configured to transmit to the second information processing apparatus a notification that synchronization of all the data forming the synchronization target group has been normally established.

10. The information processing apparatus according to claim 1, wherein the processor is configured to, if data to be included in the synchronization target group is updated in the information processing apparatus with the synchronization target group being in a present synchronization process, determine whether to establish synchronization on the updated data in the present synchronization process in accordance with a predetermined condition.

11. An information processing apparatus establishing data synchronization with a second information processing apparatus, comprising:
a processor configured to:
register, in update log information, identification information on groups each including related data among data updated in the information processing apparatus;
transmit the update log information to the second information processing apparatus at a start of a synchronization process of the data; and
perform in response to the transmission of the update log information the synchronization process on each synchronization target group specified by the second information processing apparatus to establish synchronization on data forming the synchronization group, the synchronization target group being one of the groups.

12. The information processing apparatus according to claim 11, wherein the processor is configured to, if the identification information on the synchronization target group has been registered in the update log information, delete the identification information on the synchronization target group from the update log information after the synchronization process is normally completed.

13. The information processing apparatus according to claim 11, wherein the processor is configured to, if the synchronization process is normally completed, transmit a notification of a normal completion to the second information processing apparatus.

14. The information processing apparatus according to claim 1, wherein the second information processing apparatus is formed on a cloud.

15. The information processing apparatus according to claim 11, wherein the second information processing apparatus is formed on a cloud.

16. A non-transitory computer readable medium storing a program causing a computer to execute a process for processing information, the process comprising:
registering, in information processing apparatus update log information, identification information on groups each including related data among data updated in an information processing apparatus;
in response to reception of second information processing apparatus update log information including identification information on a group including related data among data updated in a second information processing apparatus, performing a synchronization process by checking the second information processing apparatus update log information against the information processing apparatus update log information, the synchronization process establishing synchronization on data forming each synchronization target group, the synchronization target group being one of the groups and being identified as a synchronization target by the identification information thereof; and
deleting the identification information on the synchronization target group from the information processing apparatus update log information if synchronization is established on all data forming the synchronization target group and the identification information on the synchronization target group is included in the information processing apparatus update log information.
